(19) United States
(12) Patent Application Publication
(10) Pub. No.: US 2021/0115248 A1
(43) Pub. Date: Apr. 22, 2021

(54) POLYCARBONATE COMPOSITION WITH GOOD FLAME RETARDANCY

(71) Applicant: Covestro Deutschland AG, Leverkusen (DE)

(72) Inventors: Vera Taschner, Langenfeld (DE); Dirk Kurzidim, Pulheim-Stommeln (DE); Thomas Hoehnk, Grevenbroich (DE); Klaus Kraner, Solingen (DE); Birte Saemisch, Köln (DE); Thomas Eckel, Dormagen (DE); Eckhard Wenz, Köln (DE); Reiner Rudolf, Langenfeld (DE); Sven Hobeika, Solingen (DE); Matthias Kroh, Rosenfeld (DE)

(21) Appl. No.: 16/772,321

(22) PCT Filed: Dec. 13, 2018
(86) PCT No.: PCT/EP2018/084655

§ 371 Date: Jun. 12, 2020

(30) Foreign Application Priority Data
Dec. 20, 2017 (EP) 17208734.8

(51) Int. Cl. C08L 69/00; C08L 51/00; C08L 51/08; C08K 3/38; C08K 3/34; C08K 5/00; C08K 5/521; C08K 5/524; C08K 5/5399

(52) U.S. Cl. CPC C08L 69/005; C08L 51/003; C08L 51/085; C08K 3/38; C08K 3/34; C08K 5/0066; C08L 2203/30; C08K 5/524; C08K 5/5399; C08K 2003/385; C08K 2201/005; C08L 2201/02; C08K 5/521

(57) ABSTRACT

The invention relates to a composition for production of a thermoplastic moulding compound, wherein the composition comprises or consists of the following constituents:
A) 50-90% by weight of aromatic polycarbonate or polyestercarbonate having a relative solution viscosity of at least 1.285, measured in CH₂Cl₂ as solvent at 25° C. and a concentration of 0.5 g/100 ml,
B) 1-10% by weight of rubber-modified graft polymer,
C) 2.5-10% by weight of boron nitride,
D) 4-20% by weight of talc,
E) 2-20% by weight of phosphorus-containing flame retardant,
F) 0-20% by weight of further additives,
and to a process for producing the thermoplastic moulding compound, to the moulding compound itself, to the use of the moulding compound for production of mouldings and to the mouldings themselves.

The invention relates to a polycarbonate composition for production of a thermoplastic moulding compound, to a process for producing the thermoplastic moulding compound, to the moulding compound itself, to the use of the moulding compound for production of mouldings and to the mouldings themselves.

Polycarbonate compositions have long been known. Numerous patent applications additionally state that they can be improved in terms of their toughness properties by the use of rubber-modified graft polymers. It is also known that the use of phosphorus-containing flame retardants can achieve very good flame retardancy.

The variation of the constituents and the proportions thereof in the compositions allow the thermal, rheological and mechanical properties of the moulding compounds to be adapted to the particular requirements within wide ranges.

WO 2007/107252 A1 discloses impact-modified polycarbonate compositions comprising branched aromatic polycarbonate and/or branched aromatic polyestercarbonate, graft polymer containing one or more graft bases selected from the group of the silicone rubbers and silicone-acrylate rubbers, talc, phosphorus-containing flame retardant, one or more inorganic boron compounds and anti-dripping agents, which achieve elevated fire protection demands.

WO 99/57198 describes PC/ABS moulding compounds that have been rendered flame retardant with an oligophosphate and in which linear or branched polycarbonates with high molecular weight are used. The rheological properties of the moulding compounds described permit processing by an extrusion process.

EP 2492303 A1 discloses polymer compositions comprising a thermoplastic such as polycarbonate or polycarbonate/ABS and hexagonal boron nitride. The compositions may be modified with flame retardants and feature low longitudinal extension when heated and high dimensional stability.

US 2014/0356551 A1 discloses thermoplastic compositions comprising polycarbonate and an inorganic filler, and optionally graft polymer, vinyl copolymer and further additives. The compositions can be used to produce moulded articles having high surface quality, high dimensional stability and high heat distortion resistance.

WO 01/81470 discloses flame-retardant compositions comprising polyester, nitrogen-containing flame retardants, phosphorus-containing flame retardants, polytetrafluoroethylene and a component comprising zinc and/or boron selected from zinc sulfite, zinc borate and boron nitride. This component improves performance in the glow wire test (GWT).

For use in rail vehicles, from a technical and regulatory point of view, particularly high demands are made on the interior materials. For instance, the mouldings used should have high stiffness and good stability to aggressive media and simultaneously withstand specific flame retardancy tests as described, for example, in EN45545.

This profile of requirements is not fulfilled to an adequate degree by the moulding compounds known from the prior art.

It was therefore desirable to provide moulding compounds made from impact-modified PC blends of high flame retardancy with an optimal combination of high modulus of elasticity and good chemical stability, with simultaneously low release of heat to ISO 5660-1 and low smoke gas density to ISO 5659-2 of the mouldings made from the moulding compounds.

It has been found that, surprisingly, the desired profile of properties is exhibited by a composition for producing a thermoplastic moulding compound, wherein the composition contains or consists of the following constituents:

A) 50-90% by weight, preferably 55-80% by weight, more preferably 60-75% by weight, of aromatic polycarbonate or polyestercarbonate having a relative solution viscosity of at least 1.285, measured in CH₂Cl₂ as solvent at 25° C. and a concentration of 0.5 g/100 ml,

B) 1-10% by weight, preferably 1-8% by weight, more preferably 1-6% by weight, of rubber-modified graft polymer,

C) 2.5-10% by weight, preferably 2.5-8% by weight, more preferably 3-6% by weight, of boron nitride,

D) 4-20% by weight, preferably 5-15% by weight, more preferably 6-13% by weight, of talc,

E) 2-20% by weight, preferably 3-15% by weight, more preferably 5-13% by weight, of phosphorus-containing flame retardant,

F) 0-20% by weight, preferably 0.1-10% by weight, more preferably 0.3-6% by weight, of further additives.

In a preferred embodiment, the composition consists of components A-F to an extent of at least 90% by weight, more preferably to an extent of at least 95% by weight. Most preferably the composition consists solely of components A-F.

Preferably, a modulus of elasticity to ISO 527 of at least 4000 MPa should be achieved. Likewise preferably, as a measure of chemical stability, the time until fracture in the ESC (environmental stress cracking) test with rapeseed oil as test medium at 2.4% edge fibre elongation should be at least two hours. Preferably, in the testing of the heat release, an MARHE (maximum average rate of heat emission) value of 90 kW/m² should not be exceeded.

Preferably, in the testing of smoke gas evolution, a Ds(4) value of 300 and a VOF 4 value of 600 min should not be exceeded.

Component A

Polycarbonates in the context of the present invention are either homopolycarbonates or copolycarbonates and/or polyestercarbonates; the polycarbonates may be linear or branched in a known manner. According to the invention, it is also possible to use mixtures of polycarbonates.

The thermoplastic polycarbonates including the thermoplastic aromatic polyestercarbonates have a relative solution viscosity at 25° C. in CH₂Cl₂ and a concentration of 0.5 g per 100 ml of CH₂Cl₂ of 1.285 to 1.40, preferably 1.29 to 1.36.

A portion, up to 80 mol %, preferably from 20 mol % to 50 mol %, of the carbonate groups in the polycarbonates used in accordance with the invention may have been replaced by aromatic dicarboxylic ester groups. Such polycarbonates, which contain both acid radicals of carbonic acid and acid radicals of aromatic dicarboxylic acids incorporated into the molecular chain, are referred to as aromatic polyestercarbonates. In the context of the present invention, they are covered by the umbrella term of thermoplastic aromatic polycarbonates.

The polycarbonates are prepared in a known manner from diphenols, carbonic acid derivatives, optionally chain terminators and optionally branching agents, and the polyestercarbonates are prepared by replacing a portion of the carbonic acid derivatives with aromatic dicarboxylic acids or derivatives of the dicarboxylic acids, to a degree according to the extent to which the carbonate structural units in the aromatic polycarbonates are to be replaced by aromatic dicarboxylic ester structural units.

Dihydroxyaryl compounds suitable for producing polycarbonates include those of formula (1)

HO—Z—OH (1)

in which
Z is an aromatic radical which has 6 to 30 carbon atoms and may contain one or more aromatic rings, may be substituted and may contain aliphatic or cycloaliphatic radicals or alkylaryls or heteroatoms as bridging elements.

Preferably, Z in formula (1) is a radical of the formula (2)

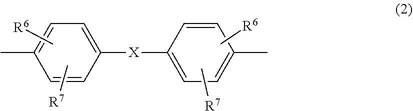

in which
R⁶ and R⁷ are independently H, C₁- to C₁₈-alkyl-, C₁- to C₁₈-alkoxy, halogen such as Cl or Br or in each case optionally substituted aryl or aralkyl, preferably H or C₁- to C₁₂-alkyl, more preferably H or C₁- to C₈-alkyl and most preferably H or methyl, and
X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, and also C₆- to C₁₂-arylene which may optionally be fused to aromatic rings containing further heteroatoms.

Preferably, X is a single bond, C₁- to C₅-alkylene, C₂- to C₅-alkylidene, C₅- to C₆-cycloalkylidene, —O—, —SO—, —CO—, —S—, —SO₂—

or a radical of the formula (2a)

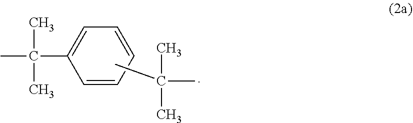

Examples of dihydroxyaryl compounds (diphenols) are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

Examples of diphenols suitable for the preparation of the polycarbonates to be used in accordance with the invention are hydroquinone, resorcinol, dihydroxydiphenyl, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes and alkylated, ring-alkylated and ring-halogenated compounds thereof.

Preferred diphenols are 4,4′-dihydroxydiphenyl, 2,2-bis(4-hydroxyphenyl)-1-phenylpropane, 1,1-bis(4-hydroxyphenyl)phenylethane, 2,2-bis(4-hydroxyphenyl)propane, 2,4-bis(4-hydroxyphenyl)-2-methylbutane, 1,3-bis[2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,3-bis[2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred diphenols are 4,4′-dihydroxydiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

These and further suitable diphenols are described, for example, in U.S. Pat. Nos. 2,999,835 A, 3,148,172 A, 2,991,273 A, 3,271,367 A, 4,982,014 A and 2,999,846 A, in German published specifications 1 570 703 A, 2 063 050 A, 2 036 052 A, 2 211 956 A and 3 832 396 A, in French patent 1 561 518 A1, in the monograph “H. Schnell, Chemistry and Physics of Polycarbonates, Interscience Publishers, New York 1964, p. 28 ff.; p. 102 ff.”, and in “D. G. Legrand, J. T. Bendler, Handbook of Polycarbonate Science and Technology, Marcel Dekker New York 2000, p. 72ff.”.

In the case of the homopolycarbonates, only one diphenol is used; in the case of copolycarbonates, two or more diphenols are used. The diphenols used, like all the other chemicals and auxiliaries added to the synthesis, may be contaminated with the impurities originating from their own synthesis, handling and storage. However, it is desirable to work with the purest possible raw materials.

The monofunctional chain terminators required to control the molecular weight, such as phenols or alkylphenols, especially phenol, p-tert-butylphenol, isooctylphenol, cumylphenol, the chlorocarbonic esters thereof or acid chlorides of monocarboxylic acids or mixtures of these chain terminators, are either supplied to the reaction with the bisphenoxide(s) or else added to the synthesis at any desired juncture, provided that phosgene or chlorocarbonic acid end groups are still present in the reaction mixture, or in the case of the acid chlorides and chlorocarbonic esters as chain terminators, provided that sufficient phenolic end groups of the forming polymer are available. However, it is preferable when the chain terminator(s) is/are added after the phosgenation at a location or at a juncture at which phosgene is no longer present but the catalyst has not yet been added or when they are added before the catalyst or together or in parallel with the catalyst.

Any branching agents or branching agent mixtures to be used are added to the synthesis in the same manner, but typically before the chain terminators. Typically, trisphenols, quaterphenols or acid chlorides of tri- or tetracarboxylic acids are used, or else mixtures of the polyphenols or the acid chlorides.

Some of the compounds having three or more than three phenolic hydroxyl groups that are usable as branching agents are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tris(4-hydroxyphenyl)benzene, 1,1,1-tri(4-hydroxyphenyl)ethane, tris(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane.

Some of the other trifunctional compounds are 2,4-dihydroxybenzoic acid, trimesic acid, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The amount of any branching agents to be used is 0.05 mol % to 2 mol %, again based on moles of diphenols used in each case.

The branching agents may either be included together with the diphenols and the chain terminators in the initially charged aqueous alkaline phase or be added dissolved in an organic solvent before the phosgenation.

All these measures for preparation of the polycarbonates are familiar to those skilled in the art.

Aromatic dicarboxylic acids suitable for the preparation of the polyestercarbonates are, for example, orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulfone dicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of the dicarboxylic acids are the diacyl dihalides and the dialkyl dicarboxylates, especially the dicarbonyl dichlorides and the dimethyl dicarboxylates.

The carbonate groups are replaced essentially stoichiometrically and also quantitatively by the aromatic dicarboxylic ester groups, and so the molar ratio of the coreactants is also reflected in the finished polyestercarbonate. The aromatic dicarboxylic ester groups can be incorporated either randomly or in blocks.

Preferred modes of production of the polycarbonates, including the polyestercarbonates, to be used according to the invention are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A).

In the former case the acid derivatives used are preferably phosgene and optionally dicarbonyl dichlorides; in the latter case preferably diphenyl carbonate and optionally dicarboxylic diesters. Catalysts, solvents, workup, reaction conditions etc. for polycarbonate preparation or polyestercarbonate preparation are sufficiently well-described and known in both cases.

Component B

Component B comprises rubber-modified graft polymers.

Rubber-modified graft polymers used as component B include
B.1 5% to 95%, preferably 8% to 92% and especially 10% to 60% by weight, based on component B, of at least one vinyl monomer onto
B.2 95% to 5%, preferably 92% to 8% and especially 90% to 40% by weight, based on component B, of one or more rubber-like graft bases, preferably having glass transition temperatures <10° C., more preferably <0° C., especially preferably <−20° C.

The glass transition temperature is measured by means of dynamic differential calorimetry (DSC) to the standard DIN EN 61006 at a heating rate of 10 K/min, with definition of the T_{g} as the midpoint temperature (tangent method).

The graft base B.2 generally has a median particle size (d₅₀) of 0.05 to 10 μm, preferably 0.1 to 5 μm, especially preferably 0.2 to 1 μm.

The median particle size d₅₀ is the diameter with 50% by weight of the particles above it and 50% by weight of the particles below it. It can be determined by means of ultracentrifuge measurement (W. Scholtan, H. Lange, Kolloid, Z. und Z. Polymere 250 (1972), 782-1796).

Monomers B.1 are preferably mixtures of
B.1.1 50 to 99, preferably 60 to 80 and especially 70 to 80 parts by weight, based on B.1, of vinylaromatics and/or ring-substituted vinylaromatics (such as styrene, α-methylstyrene, p-methylstyrene, p-chlorostyrene) and/or (C₁-C₈)-alkyl methacrylates, such as methyl methacrylate, ethyl methacrylate, and
B.1.2 1 to 50, preferably 20 to 40 and especially 20 to 30 parts by weight, based on B.1, of vinyl cyanides (unsaturated nitriles such as acrylonitrile and methacrylonitrile) and/or (C₁-C₈)-alkyl (meth)acrylates, such as methyl methacrylate, n-butyl acrylate, tert-butyl acrylate, and/or derivatives (such as anhydrides and imides) of unsaturated carboxylic acids, for example maleic anhydride and N-phenylmaleimide.

Preferred monomers B.1.1 are selected from at least one of the monomers styrene, α-methylstyrene and methyl methacrylate; preferred monomers B.1.2 are selected from at least one of the monomers acrylonitrile, maleic anhydride and methyl methacrylate. Particularly preferred monomers are B.1.1 styrene and B.1.2 acrylonitrile or B.1.1=B.1.2 methyl methacrylate.

Graft bases B.2 suitable for the graft polymers B are, for example, diene rubbers, EP(D)M rubbers, i.e. those based on ethylene/propylene and optionally diene, acrylate, polyurethane, silicone, chloroprene and ethylene/vinyl acetate rubbers and also silicone-acrylate composite rubbers.

Preferred graft bases B.2 are diene rubbers, for example based on butadiene and isoprene, or mixtures of diene rubbers or copolymers of diene rubbers or mixtures thereof with further copolymerizable monomers (for example according to B.1.1 and B.1.2), and also acrylate rubbers and silicone-acrylate composite rubbers.

Preferred polymers B are, for example, ABS polymers or MBS polymers, as described, for example, in DE-A 2 035 390 (=U.S. Pat. No. 3,644,574) or in DE-A 2 248 242 (=GB-A 1 409 275), or in Ullmann's, Enzyklopadie der Technischen Chemie [Ullmann's Encyclopedia of Industrial Chemistry], vol. 19 (1980), p. 280 ff.

The graft copolymers B are prepared by radical polymerization, for example by emulsion, suspension, solution or bulk polymerization, preferably by emulsion or bulk polymerization, especially by emulsion polymerization.

The gel content of the graft base B.2 is at least 30% by weight, preferably at least 40% by weight, especially at least 60% by weight, based in each case on B.2 and measured as the insoluble fraction in toluene.

The gel content of the graft base B.2 is determined at 25° C. in a suitable solvent as the fraction insoluble in these solvents (M. Hoffmann, H. Krömer, R. Kuhn, Polymeranalytik I und II [Polymer Analysis I and II], Georg Thieme-Verlag, Stuttgart 1977).

Particularly suitable graft rubbers are also ABS polymers, which are prepared by redox initiation with an initiator system composed of organic hydroperoxide and ascorbic acid according to U.S. Pat. No. 4,937,285.

Since, as is well known, the graft monomers are not necessarily grafted completely onto the graft base in the grafting reaction, according to the invention, graft polymers B are also understood to mean those products which are obtained through (co)polymerization of the graft monomers in the presence of the graft base and which are also obtained during workup. These products may accordingly also comprise free (co)polymer of the graft monomers, i.e. (co)polymer not chemically bonded to the rubber.

Suitable acrylate rubbers B.2 are preferably polymers of alkyl acrylates, optionally with up to 40% by weight, based on B.2, of other polymerizable ethylenically unsaturated monomers. The preferred polymerizable acrylic esters include C₁- to C₈-alkyl esters, for example methyl, ethyl, butyl, n-octyl and 2-ethylhexyl esters; haloalkyl esters, preferably halo-C₁-C₈-alkyl esters, such as chloroethyl acrylate, and also mixtures of these monomers.

Monomers having more than one polymerizable double bond can be copolymerized for crosslinking purposes. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, such as ethylene glycol dimethacrylate, allyl methacrylate; polyunsaturated heterocyclic compounds, such as trivinyl and triallyl cyanurate; polyfunctional vinyl compounds, such as di- and trivinylbenzenes; but also triallyl phosphate and diallyl phthalate. Preferred crosslinking monomers are allyl methacrylate, ethylene glycol dimethacrylate, diallyl phthalate and heterocyclic compounds which have at least three ethylenically unsaturated groups. Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5%, especially 0.05% to 2%, by weight, based on the graft base B.2. In the case of cyclic crosslinking monomers having at least three ethylenically unsaturated groups, it is advantageous to limit the amount to below 1% by weight of the graft base B.2.

Examples of preferred “other” polymerizable ethylenically unsaturated monomers which in addition to the acrylates may optionally be used for production of the graft base B.2 are acrylonitrile, styrene, α-methylstyrene, acrylamides, vinyl C₁-C₆-alkyl ethers, methyl methacrylate, butadiene. Preferred acrylate rubbers for use as graft base B.2 are emulsion polymers having a gel content of at least 60% by weight.

Further suitable graft bases B.2 are silicone rubbers having active grafting sites, as described in DE-A 3 704 657, DE-A 3 704 655, DE-A 3 631 540 and DE-A 3 631 539.

The graft base B.2 used may preferably also be silicone-acrylate composite rubber. These silicone-acrylate composite rubbers are preferably composite rubbers having graft-active sites, containing 10-95% by weight, preferably 50-95% by weight, of silicone rubber component B.2.1 and 90% to 5% by weight, preferably 50% to 5% by weight, of polyalkyl(meth)acrylate rubber component B.2.2, where these two rubber components penetrate one another in the composite rubber, such that they are essentially inseparable.

Silicone-acrylate composite rubbers are known and are described, for example, in U.S. Pat. No. 5,807,914, EP 430134 and U.S. Pat. No. 4,888,388.

Suitable silicone rubber components B.2.1 of the silicone-acrylate composite rubbers B.2 are silicone rubbers having graft-active sites, the preparation method for which is described, for example, in U.S. Pat. Nos. 2,891,920, 3,294,725, DE-A 3 631 540, EP 249964, EP 430134 and U.S. Pat. No. 4,888,388.

The silicone rubber according to B.2.1 is preferably prepared by emulsion polymerization in which siloxane monomer units, crosslinking or branching agents (IV) and optionally grafting agents (V) are used.

Siloxane monomer units used are, for example and with preference, dimethylsiloxane or cyclic organosiloxanes having at least 3 ring members, preferably 3 to 6 ring members, for example and with preference hexamethylcyclotrisiloxane, octamethylcyclotetrasiloxane, decamethylcyclopentasiloxane, dodecamethylcyclohexasiloxane, trimethyltriphenylcyclotrisiloxanes, tetramethyltetraphenylcyclotetrasiloxanes, octaphenylcyclotetrasiloxane.

The organosiloxane monomers can be used alone or in the form of mixtures having 2 or more monomers.

Crosslinking or branching agents (IV) used are preferably silane-based crosslinking agents have a functionality of 3 or 4, more preferably 4. Preferred examples include: trimethoxymethylsilane, triethoxyphenylsilane, tetramethoxysilane, tetraethoxysilane, tetra-n-propoxysilane and tetrabutoxysilane. The crosslinking agent can be used alone or in a mixture of two or more. Particular preference is given to tetraethoxysilane.

Examples of grafting agents (V) include: β-methacryloyloxyethyldimethoxymethylsilane, γ-methacryloyloxypropylmethoxydimethylsilane, γ-methacryloyloxypropyldimethoxymethylsilane, γ-methacryloyloxypropyltrimethoxysilane, γ-methacryloyloxypropylethoxydiethylsilane, γ-methacryloyloxypropyldiethoxymethylsilane, δ-methacryloyloxybutyldiethoxymethylsilanes and mixtures thereof.

Preferably, 0% to 20% by weight of grafting agent is used, based on the total weight of the silicone rubber.

The silicone rubber can be prepared by emulsion polymerization, as by way of example described in U.S. Pat. Nos. 2,891,920 and 3,294,725.

Suitable polyalkyl(meth)acrylate rubber components B.2.2 of the silicone-acrylate-composite rubbers can be prepared from alkyl methacrylates and/or alkyl acrylates, a crosslinking agent (VI) and a grafting agent (VII). In this context, preferred examples of alkyl methacrylates and/or alkyl acrylates are the C₁- to C₈-alkyl esters, for example methyl, ethyl, n-butyl, t-butyl, n-propyl, n-hexyl, n-octyl, n-lauryl and 2-ethylhexyl esters; haloalkyl esters, preferably halo-C₁-C₈-alkyl esters, such as chloroethyl acrylate, and mixtures of these monomers. Particular preference is given to n-butyl acrylate.

Crosslinking agents (VI) used for the polyalkyl(meth)acrylate rubber component of the silicone-acrylate rubber may be monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms, or of saturated polyols having 2 to 4 OH groups and 2 to 20 carbon atoms, for example ethylene glycol dimethacrylate, propylene glycol dimethacrylate, 1,3-butylene glycol dimethacrylate and 1,4-butylene glycol dimethacrylate. The crosslinking agents can be used alone or in mixtures of at least two crosslinking agents.

Preferred examples of grafting agents (VII) are allyl methacrylate, triallyl cyanurate, triallyl isocyanurate and mixtures thereof. It is also possible to use allyl methacrylate as crosslinking agent (VI). The grafting agents can be used alone or in mixtures of at least two grafting agents.

The amount of crosslinking agent (VI) and grafting agent (VII) is 0.1% to 20% by weight, based on the total weight of the polyalkyl(meth)acrylate rubber component of the silicone-acrylate rubber.

The silicone-acrylate composite rubber is prepared by first preparing the silicone rubber according to B.2.1 as an aqueous latex. This latex is subsequently supplemented with the alkyl methacrylates and/or alkyl acrylates to be used, the crosslinking agent (VI) and the grafting agent (VII), and a polymerization is conducted.

The silicone-acrylate composite graft rubbers mentioned are prepared by grafting the monomers B.1 onto the rubber base B.2.

This can be done by employing the polymerization methods described, for example, in EP 249964, EP 430134 and U.S. Pat. No. 4,888,388.

The silicone-acrylate composite graft rubbers mentioned as component B are commercially available. Examples include: Metablen® SX 005, Metablen® S-2001 and Metablen® SRK 200 from Mitsubishi Rayon Co. Ltd.

In a preferred embodiment, the proportion of silicone rubber B.2.1 in the silicone-acrylate composite rubber B.2 is at least 50% by weight, more preferably at least 70% by weight, based in each case on B.2.

Component C

According to the invention, boron nitride is used as component C.

In the compositions according to the invention, the boron nitride used may be a cubic boron nitride, a hexagonal boron nitride, an amorphous boron nitride, a partially crystalline boron nitride, a turbostratic boron nitride, a wurtzitic boron nitride, a rhombohedral boron nitride and/or a further allotropic form, preference being given to the hexagonal form.

The preparation of boron nitride is described, for example, in documents U.S. Pat. No. 6,652,822 B2, US 2001/0021740 A1, U.S. Pat. Nos. 5,898,009 A, 6,048,511 A, US 2005/0041373 A1, US 2004/0208812 A1, U.S. Pat. No. 6,951,583 B2 and in WO 2008/042446 A2.

The boron nitride is used in the form of platelets, powders, nanopowders, fibres and agglomerates, or a mixture of the aforementioned forms.

Preference is given to utilizing a mixture of boron nitride in the form of discrete platelets and agglomerates.

Preference is likewise given to using boron nitrides having an agglomerated particle size (D50) of 1 μm to 100 μm, preferably of 3 μm to 60 μm, more preferably of 5 μm to 30 μm, determined by laser diffraction.

In laser diffraction, particle size distributions are determined by measuring the angular dependence of the intensity of scattered light of a laser beam penetrating through a dispersed particle sample. In this method, the Mie theory of light scattering is used to calculate the particle size distribution. The measuring instrument used may, for example, be Microtac S3500. The D50 value means that 50% by volume of all the particles that occur in the material examined are smaller than the value stated.

In a further embodiment of the present invention, boron nitrides having a D50 of 0.1 μm to 50 μm, preferably of 1 μm to 30 μm, more preferably of 3 μm to 25 μm, determined by laser diffraction as described above, are utilized, preference being given to hexagonal boron nitrides.

Boron nitrides may be used with different particle size distributions in the compositions according to the invention.

In a further embodiment of the present invention, two boron nitrides having different particle size distribution are utilized, which gives rise to a bimodal distribution in the composition.

The carbon content of the boron nitrides used is ≤1% by weight, preferably ≤0.5% by weight, more preferably ≤0.2% by weight.

The purity of the boron nitrides, i.e. the proportion of pure boron nitride in the additive utilized in each case, is at least 90% by weight, preferably at least 95% by weight and further preferably at least 97% by weight.

The boron nitrides used in accordance with the invention have a surface area, determined by the BET (S. Brunauer, P. H. Emmett, E. Teller) determination method to DIN-ISO 9277 (version DIN-ISO 9277:2014-01), of 0.1 m²/g to 25 m²/g, preferably 1.0 m²/g to 10 m²/g and more preferably 2 m²/g to 9 m²/g.

The bulk density of the boron nitrides is preferably ≤1 g/cm³, more preferably ≤0.8 g/cm³ and most preferably ≤0.6 g/cm³.

Examples of commercially usable boron nitrides are Boron Nitride Cooling Filler Platelets 009, Boron Nitride Cooling Filler Platelets 012 and Boron Nitride Cooling Filler Platelets 015/400 HR from 3M™ Technical Ceramics or CoolFlow™ Boron Nitride Powder CF500 and CoolFlow™ Boron Nitride Powder CF600 Powder from Momentive Performance Materials. In addition, the boron nitrides may have been surface-modified, which increases the compatibility of the fillers with the composition according to the invention. Suitable modifiers include organic, for example organosilicon, compounds.

Component D

As component D the thermoplastic moulding compounds comprise a mineral filler based on talc.

Suitable as talc-based mineral fillers in the context of the invention are any particulate fillers that the person skilled in the art associates with talc or talcum. Also suitable are all particulate fillers that are commercially available and whose product descriptions contain as characterizing features the terms talc or talcum.

Mixtures of various mineral fillers based on talc can also be used.

Mineral fillers according to the invention have a talc content to DIN 55920 (2006 version) of greater than 80% by weight, preferably greater than 95% by weight and more preferably greater than 98% by weight, based on the overall filler composition.

Talc is to be understood as meaning a naturally occurring or synthetically produced talc.

Pure talc is a silicate with layer structure.

The talc grades used as component D feature particularly high purity, characterized by an MgO content of 28% to 35% by weight, preferably 30% to 33% by weight, especially preferably from 30.5% to 32% by weight, and an SiO₂ content of 55% to 65% by weight, preferably 58% to 64% by weight, especially preferably 60% to 62.5% by weight. The particularly preferred talc grades further feature an Al₂O₃ content of less than 5% by weight, more preferably less than 1% by weight, especially less than 0.7% by weight.

It is also particularly advantageous, and to that extent preferred, to use the talc of the invention in the form of finely ground grades with a d₅₀ median particle size from 0.2 to 10 μm, preferably from 0.5 to 5 μm, more preferably from 0.7 to 2.5 μm, and particularly preferably from 1.0 to 2.0 μm.

The median particle size d₅₀ is the diameter with 50% by weight of the particles above it and 50% by weight of the particles below it. It is also possible to use mixtures of talc grades which differ in their d₅₀ median particle size.

The talc grades to be used according to the invention preferably have an upper particle size or upper grain size d₉₇ below 50 μm, preferably below 10 μm, particularly preferably below 6 μm and with particular preference below 2.5 μm. The d₉₇ and d₅₀ values of the talc are determined by sedimentation analysis, using a Sedigraph 5100 (Micromeritics GmbH, Erftstrasse 43, 41238 Mönchengladbach, Germany) in accordance with ISO 13317-1 and ISO 13317-3 (2000 version).

The talc may have been surface-treated, e.g. silanized, in order to ensure better compatibility with the polymer. The talc may by way of example have been equipped with a coupling agent system based on functionalized silanes.

In respect of the processing and production of the moulding compounds it is also advantageous to use compacted talc.

As a result of the processing to give the moulding compound or to give mouldings, the d₉₇ and/or d₅₀ value of the talc used can be smaller in the moulding compound and/or in the moulding than in the starting material.

Component E

Phosphorus-containing flame retardants are used as component E.

Phosphorus-containing flame retardants in the context of the invention are preferably selected from the groups of the mono- and oligomeric phosphoric and phosphonic esters, phosphazenes and salts of phosphinic acid, and it is also possible to use mixtures of a plurality of compounds selected from one group or various groups among these as flame retardants. It is also possible to use other phosphorus compounds that have not been mentioned here specifically, alone or in any desired combination with other phosphorus compounds.

Preferred mono- and oligomeric phosphoric and phosphonic esters are phosphorus compounds of the general formula (III)

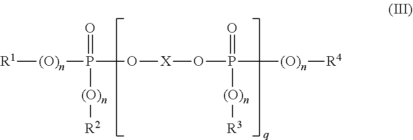

in which

R1, R2, R3 and R4 are each independently optionally halogenated C1 to C8-alkyl, in each case optionally alkyl-substituted, preferably C1 to C4-alkyl-substituted, and/or halogen-substituted, preferably chlorine- or bromine-substituted, C5- to C6-cycloalkyl, C6- to C20-aryl or C7- to C12-aralkyl,

n is independently 0 or 1,

q is 0 to 30 and

X is a mono- or polycyclic aromatic radical having 6 to 30 carbon atoms, or a linear or branched aliphatic radical having 2 to 30 carbon atoms, which may be OH-substituted and may contain up to 8 ether bonds.

Preferably, R1, R2, R3 and R4 are each independently C1- to C4-alkyl, phenyl, naphthyl or phenyl-C1-C4-alkyl. The aromatic R1, R2, R3 and R4 groups may in turn be substituted by halogen and/or alkyl groups, preferably chlorine, bromine and/or C1- to C4-alkyl. Particularly preferred aryl moieties are cresyl, phenyl, xylenyl, propylphenyl and butylphenyl, and also the corresponding brominated and chlorinated derivatives thereof.

X in the formula (III) is preferably a mono- or polycyclic aromatic radical having 6 to 30 carbon atoms. The latter preferably derives from diphenols.

n in the formula (III) may independently be 0 or 1; n is preferably 1.

q has values of 0 to 30. When mixtures of different components of the formula (III) are used, mixtures may preferably have number-average q values of 0.3 to 10, more preferably 0.5 to 10, especially 1.05 to 1.4.

X is more preferably

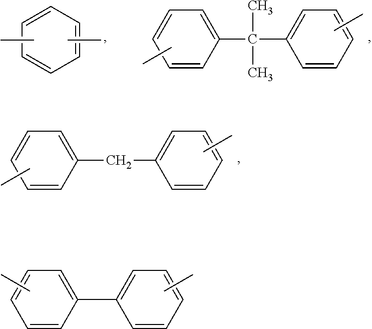

or the chlorinated or brominated derivatives thereof; more particularly, X derives from resorcinol, hydroquinone, bisphenol A or diphenylphenol. More preferably, X derives from bisphenol A.

Inventive component C used may be monophosphates (q=O), oligophosphates (q=1-30) or mixtures of mono- and oligophosphates.

Monophosphorus compounds of the formula (III) are especially tributyl phosphate, tris(2-chloroethyl) phosphate, tris(2,3-dibromopropyl) phosphate, triphenyl phosphate, tricresyl phosphate, diphenyl cresyl phosphate, diphenyl octyl phosphate, diphenyl 2-ethylcresyl phosphate, tri(isopropylphenyl) phosphate, halogen-substituted aryl phosphates, dimethyl methylphosphonate, diphenyl methylphosphenate, diethyl phenylphosphonate, triphenylphosphine oxide or tricresylphosphine oxide. Most preferred as component D is bisphenol A-based oligophosphate of formula (IIIa):

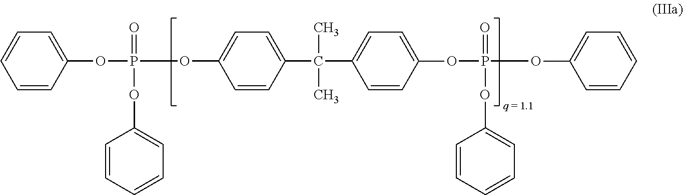

The phosphorus compounds of formula (III) are known (cf., for example, EP-A 363 608, EP-A 640 655) or can be prepared in an analogous manner by known methods (e.g. Ullmanns Enzyklopädie der technischen Chemie, vol. 18, p. 301 ff. 1979; Houben-Weyl, Methoden der organischen Chemie [Methods of Organic Chemistry], vol. 12/1, p. 43; Beilstein vol. 6, p. 177).

The mean q values can be determined by using a suitable method (gas chromatography (GC), high pressure liquid chromatography (HPLC), gel permeation chromatography (GPC)) to determine the composition of the phosphate mixture (molecular weight distribution) and using this to calculate the mean values for q.

Phosphazenes are compounds of the formulae (IVa) and (IVb)

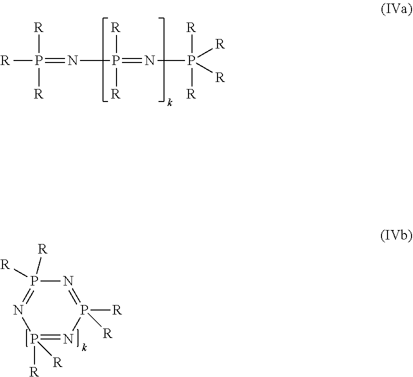

in which

R is the same or different in each case and is amino, in each case optionally halogenated, preferably fluorinated, C1- to C8-alkyl, or C1- to C8-alkoxy, in each case optionally alkyl-substituted, preferably C1- to C4-alkyl-substituted, and/or halogen-substituted, preferably chlorine- and/or bromine-substituted, C5- to C6-cycloalkyl, C6- to C20-aryl, preferably phenyl or naphthyl, C6- to C20-aryloxy, preferably phenoxy, naphthyloxy, or C7- to C12-aralkyl, preferably phenyl-C1-C4-alkyl,

k is 0 or a number from 1 to 15, preferably a number from 1 to 10.

Examples include propoxyphosphazene, phenoxyphosphazene, methylphenoxyphosphazene, aminophosphazene and fluoroalkylphosphazenes. Preference is given to phenoxyphosphazene.

The phosphazenes can be used alone or in a mixture. The R radical may always be the same, or 2 or more radicals in the formulae (IVa) and (IVb) may be different. Phosphazenes and the preparation thereof are described, for example, in EP-A 728 811, DE-A 1 961668 and WO 97/40092.

The salt of a phosphinic acid in the context of the invention is understood to mean the salt of a phosphinic acid with any metal cation. It is also possible to use mixtures of salts which differ in terms of their metal cation. The metal cations are the cations of the metals of main group 1 (alkali metals, preferably Li⁺, Na⁺, K⁺), of main group 2 (alkaline earth metals, preferably Mg²⁺, Ca²⁺, Sr²⁺, Ba²⁺, more preferably Ca²⁺) or of main group 3 (elements of the boron group, preferably Al³⁺) and/or of transition group 2, 7 or 8 (preferably Zn²⁺, Mn²⁺, Fe²⁺, Fe³⁺) of the Periodic Table.

Preference is given to using a salt or a mixture of salts of a phosphinic acid of the formula (V)

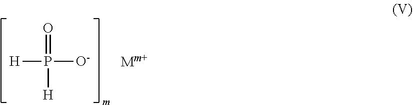

in which M^{m+} is a metal cation of main group 1 (alkali metals; m=1), of main group 2 (alkaline earth metals; m=2) or of main group 3 (m=3) or of transition group 2, 7 or 8 (where m is an integer from 1 to 6, preferably 1 to 3 and more preferably 2 or 3) of the Periodic Table.

More preferably, in formula (V),

when m=1 the metal cations M⁺=Li⁺, Na⁺, K⁺,

when m=2 the metal cations M²⁺=Mg²⁺, Ca²⁺, Sr²⁺, Ba²⁺ and

when m=3 the metal cations M³⁺=Al³⁺.

most preferred is Ca²⁺ (m=2).

In a preferred embodiment, the median particle size d₅₀ of the phosphinic salt (component C) is less than 80 μm, preferably less than 60 μm; more preferably, d₅₀ is between 10 μm and 55 μm. The median particle size d₅₀ is the diameter with 50% by weight of the particles above it and 50% by weight of the particles below it. It is also possible to use mixtures of salts which differ in terms of their median particle size d₅₀.

Component F

The composition may comprise, as component F, further commercial standard polymer additives other than component B, where additives used are especially and preferably selected from the group of the flame retardant synergists (for example nanoscale metal oxides), anti-dripping agents, smoke inhibitors (for example zinc borate), lubricants and demoulding agents (for example pentaerythritol tetrastearate), nucleating agents, antistats, conductivity additives, stabilizers (e.g. hydrolysis, thermal ageing and UV stabilizers, and also transesterification inhibitors and acid/base quenchers), flowability promoters, compatibilizers, further impact modifiers other than component C (with or without core-shell structure), further polymeric constituents (for example functional blend partners), fillers and reinforcers other than component D (for example carbon fibres, mica, kaolin, CaCO₃) and also dyes and pigments (for example titanium dioxide or iron oxide). It is also possible to use mixtures of different additives.

Preference is given to using, as one of the additives, zinc borate hydrate (Zn₂B₆O₁₁ 3.5H₂O) as smoke inhibitor.

In a further-preferred embodiment, the composition contains at least one polymer additive selected from the group consisting of anti-dripping agents, smoke inhibitors, stabilizers, dyes and pigments.

Antidripping agents used may, for example, be polytetrafluoroethylene (PTFE) or PTFE-containing compositions, an example being a masterbatch of PTFE with styrene- or methyl-methacrylate-containing polymers or copolymers, in the form of powder or of coagulated mixture, for example with component B.

In a preferred embodiment the composition contains pentaerythritol tetrastearate as a demoulding agent.

In a preferred embodiment the composition contains, as a stabilizer, at least one representative selected from the group consisting of sterically hindered phenols, organic phosphites, sulfur-based co-stabilizers and organic and inorganic Brønsted acids.

In a particularly preferred embodiment, the composition comprises, as stabilizer, at least one representative selected from the group consisting of octadecyl 3-(3,5-di-tert-butyl-4-hydroxyphenyl)propionate and tris(2,4-di-tert-butylphenyl) phosphite.

Production of the Moulding Compounds and Mouldings

The compositions according to the invention can be used to produce thermoplastic moulding compounds.

The thermoplastic moulding compounds according to the invention can be produced for example by mixing the respective constituents of the compositions and melt compounding and melt extruding the resulting mixture at temperatures of preferably 200° C. to 320° C., more preferably at 240° C. to 300° C., in customary apparatuses, for example internal kneaders, extruders and twin-shaft screw systems, in a known manner.

In the context of this application, this process is generally referred to as compounding.

The term moulding compound is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. It is therefore possible by way of example that some of the constituents are metered into the system by way of the main intake of an extruder and that the remaining constituents are introduced subsequently in the compounding process by way of an ancillary extruder.

The invention also provides processes for producing the inventive moulding compounds and for the use of the moulding compounds to produce mouldings.

The moulding compounds according to the invention can be used to produce mouldings of any kind. These may be produced by injection moulding, extrusion and blow-moulding processes for example. A further form of processing is the production of mouldings by deep drawing from previously produced sheets or films. The moulding compounds according to the invention are particularly suitable for processing by extrusion, blow-moulding and thermoforming methods.

The constituents of the compositions may also be metered directly into an injection moulding machine or into an extrusion unit and processed to mouldings.

Examples of such mouldings that can be produced from the compositions and moulding compounds according to the invention are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automotive sector. The compositions and moulding compounds according to the invention are also suitable for production of the following mouldings or moulded articles: ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, moulded parts for sanitation and bath equipment, protective grilles for ventilation openings and housings for garden equipment.

The mouldings are particularly suitable for interior fitout components for rail vehicles.

Further embodiments 1 to 25 of the present invention are described hereinbelow:

1. Composition for production of a thermoplastic moulding compound, wherein the composition comprises or consists of the following constituents:

A) 50-90% by weight of aromatic polycarbonate or polyestercarbonate having a relative solution viscosity of at least 1.285, measured in CH₂Cl₂ as solvent at 25° C. and a concentration of 0.5 g/100 ml,

B) 1-10% by weight of rubber-modified graft polymer,

C) 2.5-10% by weight of boron nitride,

D) 4-20% by weight of talc,

E) 2-20% by weight of phosphorus-containing flame retardant,

F) 0-20% by weight of further additives.

2. Composition according to Embodiment 1, wherein component A is branched polycarbonate based on bisphenol A.

3. Composition according to Embodiment 1 or 2, wherein component A has a relative solution viscosity of 1.285 to 1.40, measured in CH₂Cl₂ as solvent at 25° C. and a concentration of 0.5 g/100 ml.

4. Composition according to Embodiment 1 or 2, wherein component A has a relative solution viscosity of 1.29 to 1.36, measured in CH₂Cl₂ as solvent at 25° C. and a concentration of 0.5 g/100 ml.

5. Composition according to any of the preceding embodiments, comprising, as component B, one or more graft polymers of

B.1 5% to 95% by weight of at least one vinyl monomer onto

B.2 95% to 5% by weight of at least one graft base selected from the group consisting of diene rubbers, EP(D)M rubbers, acrylate rubbers, polyurethane rubbers, silicone rubbers, chloroprene rubbers and ethylene/vinyl acetate rubbers, and also silicone/acrylate composite rubbers.

6. Composition according to Embodiment 5, wherein the proportion of B.1 in component B is 10% to 60% by weight and the proportion of component B.2 is 90% to 40% by weight, based in each case on component B.

7. Composition according to either of Embodiments 5 and 6, wherein the graft base B.2 is a silicone-acrylate composite rubber composed of mutually penetrating silicone rubber and polyalkyl(meth)acrylate rubber, wherein the proportion of silicone rubber is 50-95% by weight based on B.2.

8. Composition according to any of the preceding embodiments, wherein component C is hexagonal boron nitride.

9. Composition according to any of the preceding embodiments, wherein component C has a median particle size D50 of 0.1 to 50 μm, determined by laser diffraction.

10. Composition according to any of the preceding embodiments, wherein component C has a median particle size D50 of 3 to 25 μm, determined by laser diffraction.

11. Composition according to any of the preceding embodiments, wherein the boron nitride has a carbon content of ≤0.2% by weight.

12. Composition according to any of the preceding embodiments, wherein the boron nitride has a purity of at least 97% by weight.

13. Composition according to any of the preceding embodiments, wherein the boron nitride has a BET surface area of 2 m²/g to 9 m²/g.

14. Composition according to any of the preceding embodiments, wherein component D has a median particle size d₅₀ of 0.7 to 2.5 μm determined by sedimentation analysis.

15. Composition according to any of the preceding embodiments, wherein component D has a median particle size d₅₀ of 1.0 to 2.0 μm determined by sedimentation analysis.

16. Composition according to any of the preceding embodiments, wherein component E is at least one flame retardant selected from the group comprising oligophosphate, phosphazene and salts of phosphinic acid.

17. Composition according to Embodiment 16, wherein component E is a compound having the following structure:

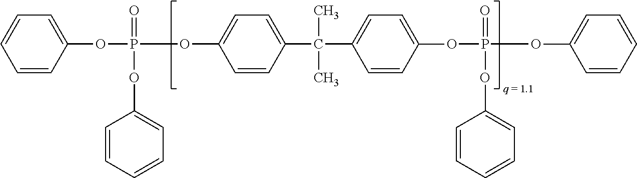

18. Composition according to any of the preceding embodiments, comprising, as component F, at least one additive selected from the group comprising lubricants and mould release agents, antidripping agents, nucleating agents, antistats, conductivity additives, stabilizers, flowability promoters, compatibilizers, further impact modifiers other than component B, further polymeric blend partners, fillers and reinforcers other than component D, and dyes and pigments.

19. Composition according to any of the preceding embodiments, comprising, as component F, zinc borate hydrate Zn₂B₆O₁₁ 3.5H₂O.

20. Composition according to any of the preceding embodiments containing or consisting of

55-80% by weight of component A,

1-8% by weight of component B,

2.5-8% by weight of component C,

5-15% by weight of component D,

3-15% by weight of component E,

0.1-10% by weight of component F.

21. Composition according to any of the preceding embodiments containing or consisting of

60-75% by weight of component A,

1-6% by weight of component B,

3-6% by weight of component C,

6-13% by weight of component D,

5-13% by weight of component E,

0.3-6% by weight of component F.

22. Composition according to any of the preceding embodiments, characterized in that the composition consists solely of components A) to F).

23. Use of a composition according to any of Embodiments 1 to 22 for production of injection mouldings or thermoformed mouldings.

24. Mouldings obtainable from a composition according to any of embodiments 1 to 22.

25. Moulding according to Embodiment 24 having a tensile modulus of elasticity of at least 4000 MPa measured to ISO 527, heat release according to ISO 5660-1 of not more than 90 kW/m², a smoke gas density to ISO 5659-2 of Ds(4) not more than 300 and VOF4 of not more than 600, and a time before fracture in the ESC test in rapeseed oil at an edge fibre elongation of 2.4% of at least two hours.

### EXAMPLES

Component A-1

Branched polycarbonate based on bisphenol A and having a relative solution viscosity of η_{rcl}=1.325, measured in CH₂Cl₂ as solvent at 25° C. and a concentration of 0.5 g/100 ml, which has been branched by use of 0.4% by weight of THPE (1,1,1-tris(p-hydroxyphenyl)ethane) based on the sum total of bisphenol A and THPE.

Component A-2

Linear polycarbonate based on bisphenol A and having a relative solution viscosity of η_{rcl}=1.32, measured in CH₂Cl₂ as solvent at 25° C. and a concentration of 0.5 g/100 ml.

Component A-3

Linear polycarbonate based on bisphenol A and having a relative solution viscosity of η_{rcl}=1.29, measured in CH₂Cl₂ as solvent at 25° C. and a concentration of 0.5 g/100 ml.

Component A-4

Linear polycarbonate based on bisphenol A and having a relative solution viscosity of η_{rcl}=1.28, measured in CH₂Cl₂ as solvent at 25° C. and a concentration of 0.5 g/100 ml.

Component B-1

Impact modifier, graft polymer of
B-1.1 11% by weight of methyl methacrylate onto
B-1.2 89% by weight of a silicone-acrylate composite rubber as graft base, where the silicone-acrylate rubber contains
   B-1.2.1 92% by weight of silicone rubber and
   B-1.2.2 8% by weight of polyalkyl(meth)acrylate rubber, and
   where these two rubber components B.2.1 and B.2.2 penetrate one another in the composite rubber, such that they are essentially inseparable from one another.

Component B-2

Impact modifier, graft polymer of
B-2.1 17% by weight of methyl methacrylate onto
B-2.2 83% by weight of a silicone-acrylate composite rubber as graft base, where the silicone-acrylate rubber contains
   B-2.2.1 11% by weight of silicone rubber and
   B-2.2.2 89% by weight of polyalkyl(meth)acrylate rubber, and
   where these two rubber components B.2.1 and B.2.2 penetrate one another in the composite rubber, such that they are essentially inseparable from one another.

Component B-3

Impact modifier, ABS graft polymer with core-shell structure, prepared by emulsion polymerization of 43% by weight based on the ABS polymer of a mixture of 27% by weight of acrylonitrile and 73% by weight of styrene in the presence of 57% by weight based on the ABS polymer of a particulate-crosslinked polybutadiene rubber (median particle diameter d₅₀=0.35 μm).

Component B-4

Impact modifier, MBS graft polymer with core-shell structure, prepared by emulsion polymerization of 24% by weight of methyl methacrylate in the presence of 76% by weight based on the MBS polymer of a particulate-crosslinked copolymer of 88% by weight of butadiene and 12% by weight of styrene.

Component B-5

Impact modifier, MB graft polymer with core-shell structure, prepared by emulsion polymerization of 25% by weight of methyl methacrylate in the presence of 75% by weight based on the MB polymer of a particulate-crosslinked polybutadiene rubber.

Component B-6

Impact modifier, graft polymer with core-shell structure, prepared by emulsion polymerization of 40% by weight of methyl methacrylate in the presence of 60% by weight based on the graft polymer of a particulate-crosslinked poly-n-butylacrylate rubber (median particle diameter d₅₀=0.50 μm).

Component C

Hexagonal boron nitride; (BN, CAS No. 10043-11-5) having a median particle size D50=16 μm, a purity of >97% by weight, a carbon content of <0.1% by weight and a BET surface area of 8 m²/g.

Component D

Talc, Jetfine 3CA from Imerys with an MgO content of 32% by weight, an SiO₂ content of 61% by weight and an Al₂O₃ content of 0.3% by weight, median particle size d₅₀=1.0 μm.

Component E-1

Bisphenol-A-based oligophosphate having a phosphorus content of 8.9% by weight.

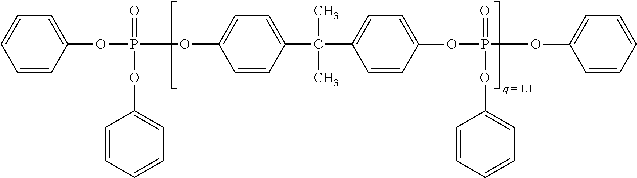

Component E-2

Phenoxyphosphazene of formula (a) with 70% by weight n=1 and 30% by weight n=2-10.

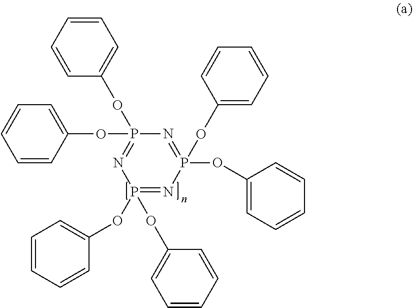

Component E-3

Phoslite MB 9545, masterbatch composed of 45% by weight of calcium phosphinate and 55% by weight of aromatic, bisphenol A-based polycarbonate (manufacturer: Italmatch Chemicals).

Component F-1

Zinc borate hydrate (Zn₂B₆O₁₁ 3.5H₂O, CAS No. 138265-88-0)

Component F-2

Teflon PTFE CFP 6000 X, polytetrafluoroethylene powder (manufacturer: Chemours)

Component F-3

Pentaerythritol tetrastearate as lubricant/demoulding agent

Component F-4

Heat stabilizer, Irganox™ B900

(mixture of 80% Irgafos® 168 (tris(2,4-di-tert-butylphenyl) phosphite) and 20% Irganox™ 1076 (2,6-di-tert-butyl-4-(octadecanoxycarbonylethyl)phenol) (manufacturer: BASF AG)

Production and Testing of the Moulding Compounds

In a twin-screw extruder (Werner und Pfleiderer ZSK-25), the feedstocks listed in Table 1 are compounded and pelletized at a speed of 225 rpm and a throughput of 20 kg/h at a machine temperature of 260° C.

The finished pelletized materials are processed in an injection-moulding machine to give the appropriate specimens (melt temperature 240° C., mould temperature 80° C., flow front speed 240 mm/s).

Characterization is effected to ISO 180/1U (1982 version, Izod impact resistance), ISO 527 (1996 version, tensile modulus of elasticity), ISO 306 (2013 version, Vicat softening temperature, Method B with load 50 N and a heating rate of 120 K/h), ISO 11443 (2014 version, melt viscosity) and ISO 1133 (2012 version, melt volume flow rate (MVR) at 260° C./5 kg). A measure used for the chemical resistance of the compositions produced is the environmental stress cracking (ESC) test according to DIN EN ISO 22088 (2006 version), which is conducted as follows: with rapeseed oil as test medium, exposure at 2.4% edge fibre elongation; in other words, the duration at which fracture of the test specimen (test bar of dimensions 80×10×4 mm) occurs is ascertained and reported.

The heat release is tested on test specimens of thickness 3 mm to ISO 5660-1:2015 (cone calorimeter) at irradiation intensity 50 kW/m²; the MARHE (=maximum average rate of heat emission) value is determined. For classification in hazard level 2 (HL2) according to specification set R1/R6 of the European rail vehicles standard EN45545-2:2013, an MARHE value of 90 kW/m² must not be exceeded.

Smoke gas evolution is measured on test specimens of thickness 3 mm in accordance with ISO 5659-2:2006 at an irradiation intensity of 50 kW/m² without an ignition flame, for the determination of Ds(4) and VOF 4. For classification in hazard level 2 (HL2) according to specification set R1/R6 of the European rail vehicles standard EN45545-2:2013, a D(s)4 value of 300 and a VOF 4 value of 600 min must not be exceeded.

It is apparent from Table 1 that the compositions of Examples 3-7, 9-11, 14-21 and 24-35 achieve the object of the invention, i.e. a combination of high modulus of elasticity (at least 4000 MPa) and good chemical stability (time before fracture with rapeseed oil at least 2 h, with edge fibre elongation 2.4%) with simultaneously low heat release according to ISO 5660-1:2015 (MARHE max. 90 kW/m²) and low smoke gas density to ISO 5659-2:2006 (Ds(4) max. 300 and VOF4 max. 600 min).

The properties of the compositions of Examples 1-5 show that at least 2.5% by weight of boron nitride must be present.

Examples 5-8 show that, as well as branched polycarbonate, it is also possible to use linear polycarbonate based on bisphenol A when it has a greater relative solution viscosity than η_{rcl}=1.28, measured in CH₂Cl₂ as solvent at 25° C. and a concentration of 0.5 g/100 ml.

Examples 9-13 show that at least 1.0% by weight of an impact modifier must be used, the chemical nature of the impact modifier being variable (Examples 14-18).

The properties of the compositions of Examples 19-23 show that at least 4% by weight of talc must be used. The use of zinc borate hydrate is optional (Examples 24-27).

Examples 28-35 show that both the content and the chemical nature of the phosphorus-containing flame retardant are variable.

TABLE 1
Composition and properties of the moulding compounds

| Feedstock | | | | 1 | 2 | | | | | | 8 |
|---|---|---|---|---|---|---|---|---|---|---|---|
| (% by wt.) | | | | (comp.) | (comp.) | 3 | 4 | 5 | 6 | 7 | (comp.) |
| A-1 | | | | 71 | 70 | 69 | 68 | 67 | | | |
| A-2 | | | | | | | | | 67 | | |
| A-3 | | | | | | | | | | 67 | |
| A-4 | | | | | | | | | | | 67 |
| B-1 | | | | 4.5 | 4.5 | 4.5 | 4.5 | 4.5 | 4.5 | 4.5 | 4.5 |
| C | | | | 1 | 2 | 3 | 4 | 5 | 5 | 5 | 5 |
| D | | | | 9.5 | 9.5 | 9.5 | 9.5 | 9.5 | 9.5 | 9.5 | 9.5 |
| E-1 | | | | 9.5 | 9.5 | 9.5 | 9.5 | 9.5 | 9.5 | 9.5 | 9.5 |
| F-1 | | | | 3.8 | 3.8 | 3.8 | 3.8 | 3.8 | 3.8 | 3.8 | 3.8 |
| F-2 | | | | 0.4 | 0.4 | 0.4 | 0.4 | 0.4 | 0.4 | 0.4 | 0.4 |
| F-3 | | | | 0.2 | 0.2 | 0.2 | 0.2 | 0.2 | 0.2 | 0.2 | 0.2 |
| F-4 | | | | 0.1 | 0.1 | 0.1 | 0.1 | 0.1 | 0.1 | 0.1 | 0.1 |
| Test | Condition | Standard | Unit | | | | | | | | |
| Izod impact | 23° C. | ISO | kJ/m² | 140 | 109 | 84 | 71 | 78 | 92 | 70 | 42 |
| resistance | | 180/1 U | | | | | | | | | |
| Tensile | 1 mm/min | ISO | MPa | 3755 | 3984 | 4150 | 4281 | 4436 | 4472 | 4198 | 4396 |
| modulus | | 527-1, -2 | | | | | | | | | |
| Vicat | 50N; | ISO | ° C. | 112 | 111 | 111 | 110 | 109 | 108 | 108 | 107 |
| softening | 120° C./h | 306 | | | | | | | | | |
| temperature | | | | | | | | | | | |
| Viscosity | | | | | | | | | | | |
| function | | | | | | | | | | | |
| Melt | 260° C. | ISO | Pas | 1180 | 1176 | 1125 | 1116 | 1017 | 880 | 642 | 422 |
| viscosity | | 11443 | | | | | | | | | |
| [100 s − 1] | | | | | | | | | | | |
| Melt | 260° C. | ISO | Pas | 421 | 415 | 392 | 393 | 395 | 386 | 319 | 227 |
| viscosity | | 11443 | | | | | | | | | |
| [1000 s − 1] | | | | | | | | | | | |
| Melt | 260° C. | ISO | Pas | 325 | 319 | 304 | 305 | 306 | 299 | 254 | 193 |
| viscosity | | 11443 | | | | | | | | | |
| [1500 s − 1] | | | | | | | | | | | |
| Melt | 260° C.; | ISO | cm3/ | 7.5 | 7.6 | 7.6 | 7.8 | 7.9 | 12.4 | 17.9 | 28.0 |
| volume | 5 kg | 1133 | (10 min) | | | | | | | | |
| flow rate | | | | | | | | | | | |
| (MVR) | | | | | | | | | | | |
| ESC in | | | | | | | | | | | |
| rapeseed oil | | | | | | | | | | | |
| Time until | 2.4% edge | ISO | h | 21 | 20 | 16 | 15 | 23 | 23 | 2.3 | 0.3 |
| fracture | fibre | 4599 | | | | | | | | | |
| | elongation | | | | | | | | | | |
| Heat | 50 kW/m² | ISO | kW/m² | 83 | 71 | 64 | 70 | 59 | 47 | 50 | 57 |
| release | | 5660-1 | | | | | | | | | |
| (3 mm) | | | | | | | | | | | |
| MARHE | | | | | | | | | | | |
| Smoke gas | 50 kW/m² | ISO | | | | | | | | | |
| density | without | 5659-2 | | | | | | | | | |
| (3 mm) | ignition | | | | | | | | | | |
| | flame | | | | | | | | | | |
| Ds(4) | | | | 212 | 239 | 203 | 169 | 167 | 207 | 205 | 185 |
| VOF4 | | | min | 432 | 404 | 322 | 301 | 324 | 352 | 340 | 277 |

| Feedstock | | | | | | | 12 | 13 | | | | | |
|---|---|---|---|---|---|---|---|---|---|---|---|---|---|
| (% by wt.) | | | | 9 | 10 | 11 | (comp.) | (comp.) | 14 | 15 | 16 | 17 | 18 |
| A-1 | | | | 68 | 69 | 70 | 71 | 71.5 | 67 | 67 | 67 | 67 | 67 |
| B-1 | | | | 3.5 | 2.5 | 1.5 | 0.5 | 0 | | | | | |
| B-2 | | | | | | | | | 4.5 | | | | |
| B-3 | | | | | | | | | | 4.5 | | | |
| B-4 | | | | | | | | | | | 4.5 | | |
| B-5 | | | | | | | | | | | | 4.5 | |
| B-6 | | | | | | | | | | | | | 4.5 |
| C | | | | 5 | 5 | 5 | 5 | 5 | 5 | 5 | 5 | 5 | 5 |
| D | | | | 9.5 | 9.5 | 9.5 | 9.5 | 9.5 | 9.5 | 9.5 | 9.5 | 9.5 | 9.5 |
| E-1 | | | | 9.5 | 9.5 | 9.5 | 9.5 | 9.5 | 9.5 | 9.5 | 9.5 | 9.5 | 9.5 |
| F-1 | | | | 3.8 | 3.8 | 3.8 | 3.8 | 3.8 | 3.8 | 3.8 | 3.8 | 3.8 | 3.8 |
| F-2 | | | | 0.4 | 0.4 | 0.4 | 0.4 | 0.4 | 0.4 | 0.4 | 0.4 | 0.4 | 0.4 |
| F-3 | | | | 0.2 | 0.2 | 0.2 | 0.2 | 0.2 | 0.2 | 0.2 | 0.2 | 0.2 | 0.2 |
| F-4 | | | | 0.1 | 0.1 | 0.1 | 0.1 | 0.1 | 0.1 | 0.1 | 0.1 | 0.1 | 0.1 |
| Test | Condition | Standard | Unit | | | | | | | | | | |
| Izod impact | 23° C. | ISO | kJ/m² | 76 | 57 | 38 | 31 | 27 | 74 | 47 | 49 | 44 | 41 |
| resistance | | 180/1 U | | | | | | | | | | | |
| Tensile | 1 mm/min | ISO | MPa | 4473 | 4637 | 4954 | 5189 | 5495 | 4662 | 4903 | 4812 | 4755 | 4811 |
| modulus | | 527-1, -2 | | | | | | | | | | | |
| Vicat | 50N; | ISO | ° C. | 110 | 111 | 111 | 110 | 108 | 110 | 110 | 110 | 110 | 111 |
| softening | 120° C./h | 306 | | | | | | | | | | | |
| temperature | | | | | | | | | | | | | |
| Viscosity | | | | | | | | | | | | | |
| function | | | | | | | | | | | | | |
| Melt | 260° C. | ISO | Pas | 1102 | 1066 | 915 | 626 | 403 | 1183 | 995 | 1014 | 1037 | 1043 |
| viscosity | | 11443 | | | | | | | | | | | |
| [100 s − 1] | | | | | | | | | | | | | |
| Melt | 260° C. | ISO | Pas | 401 | 401 | 362 | 274 | 201 | 423 | 382 | 391 | 401 | 385 |
| viscosity | | 11443 | | | | | | | | | | | |
| [1000 s − 1] | | | | | | | | | | | | | |
| Melt | 260° C. | ISO | Pas | 310 | 313 | 285 | 222 | 169 | 327 | 298 | 304 | 313 | 298 |
| viscosity | | 11443 | | | | | | | | | | | |
| [1500 s − 1] | | | | | | | | | | | | | |
| Melt | 260° C.; | ISO | cm3/ | 8.5 | 8.9 | 11.9 | 21.9 | 36.7 | 6.5 | 7.9 | 8.7 | 8.8 | 9.1 |
| volume | 5 kg | 1133 | (10 min) | | | | | | | | | | |
| flow rate | | | | | | | | | | | | | |
| (MVR) | | | | | | | | | | | | | |
| ESC in | | | | | | | | | | | | | |
| rapeseed oil | | | | | | | | | | | | | |
| Time | 2.4% edge | ISO | h | 23 | 23 | 7 | 1 | 0.1 | 20 | 20 | 20 | 20 | 20 |
| until | fibre | 4599 | | | | | | | | | | | |
| fracture | elongation | | | | | | | | | | | | |
| Heat | 50 kW/m² | ISO | kW/m² | 37 | 44 | 39 | 42 | 59 | 43 | 50 | 58 | 52 | 49 |
| release | | 5660-1 | | | | | | | | | | | |
| (3 mm) | | | | | | | | | | | | | |
| MARHE | | | | | | | | | | | | | |
| Smoke | 50 kW/m² | ISO | | | | | | | | | | | |
| gas | without | 5659-2 | | | | | | | | | | | |
| density | ignition | | | | | | | | | | | | |
| (3 mm) | flame | | | | | | | | | | | | |
| Ds(4) | | | | 217 | 162 | 140 | 117 | 154 | 248 | 203 | 249 | 247 | 254 |
| VOF4 | | | min | 363 | 317 | 227 | 186 | 225 | 415 | 294 | 421 | 469 | 454 |

| Feedstock | | | | | | | 22 | 23 | | | | |
|---|---|---|---|---|---|---|---|---|---|---|---|---|
| (% by wt.) | | | | 19 | 20 | 21 | (comp.) | (comp.) | 24 | 25 | 26 | 27 |
| A-1 | | | | 64 | 68.5 | 70 | 73 | 76.5 | 67.8 | 68.8 | 69.8 | 70.8 |
| B-1 | | | | 4.5 | 4.5 | 4.5 | 4.5 | 4.5 | 4.5 | 4.5 | 4.5 | 4.5 |
| C | | | | 5 | 5 | 5 | 5 | 5 | 5 | 5 | 5 | 5 |
| D | | | | 12.5 | 8 | 6.5 | 3.5 | 0 | 9.5 | 9.5 | 9.5 | 9.5 |
| E-1 | | | | 9.5 | 9.5 | 9.5 | 9.5 | 9.5 | 9.5 | 9.5 | 9.5 | 9.5 |
| F-1 | | | | 3.8 | 3.8 | 3.8 | 3.8 | 3.8 | 3 | 2 | 1 | 0 |
| F-2 | | | | 0.4 | 0.4 | 0.4 | 0.4 | 0.4 | 0.4 | 0.4 | 0.4 | 0.4 |
| F-3 | | | | 0.2 | 0.2 | 0.2 | 0.2 | 0.2 | 0.2 | 0.2 | 0.2 | 0.2 |
| F-4 | | | | 0.1 | 0.1 | 0.1 | 0.1 | 0.1 | 0.1 | 0.1 | 0.1 | 0.1 |
| Test | Condition | Standard | Unit | | | | | | | | | |
| Izod impact | 23° C. | ISO | kJ/m² | 67 | 73 | 106 | 128 | 144 | 59 | 62 | 64 | 64 |
| resistance | | 180/1 U | | | | | | | | | | |
| Tensile | 1 mm/min | ISO | MPa | 4729 | 4582 | 4037 | 3627 | 3302 | 4463 | 4429 | 4311 | 4320 |
| modulus | | 527-1, -2 | | | | | | | | | | |
| Vicat | 50N; | ISO | ° C. | 109 | 109 | 111 | 111 | 113 | 111 | 111 | 112 | 112 |
| softening | 120° C./h | 306 | | | | | | | | | | |
| temperature | | | | | | | | | | | | |
| Viscosity | | | | | | | | | | | | |
| function | | | | | | | | | | | | |
| Melt | 260° C. | ISO | Pas | 1093 | 1097 | 1088 | 1088 | 982 | 1077 | 1078 | 1098 | 1159 |
| viscosity | | 11443 | | | | | | | | | | |
| [100 s − 1] | | | | | | | | | | | | |
| Melt | 260° C. | ISO | Pas | 397 | 391 | 404 | 404 | 382 | 385 | 382 | 391 | 402 |
| viscosity | | 11443 | | | | | | | | | | |
| [1000 s − 1] | | | | | | | | | | | | |
| Melt | 260° C. | ISO | Pas | 306 | 303 | 317 | 317 | 300 | 295 | 291 | 301 | 311 |
| viscosity | | 11443 | | | | | | | | | | |
| [1500 s − 1] | | | | | | | | | | | | |
| Melt | 260° C.; | ISO | cm3/ | 7.2 | 7.3 | 9.3 | 9.9 | 10.4 | 7.4 | 7.4 | 7.2 | 7.6 |
| volume | 5 kg | 1133 | (10 min) | | | | | | | | | |
| flow rate | | | | | | | | | | | | |
| (MVR) | | | | | | | | | | | | |
| ESC in | | | | | | | | | | | | |
| rapeseed oil | | | | | | | | | | | | |
| Time | 2.4% edge | ISO | h | 23 | 23 | 41 | 23 | 7 | 26 | 31 | 39 | 23 |
| until | fibre | 4599 | | | | | | | | | | |
| fracture | elongation | | | | | | | | | | | |
| Heat | 50 kW/m² | ISO | kW/m² | 53 | 54 | 54 | 76 | 81 | 31 | 36 | 37 | 35 |
| release | | 5660-1 | | | | | | | | | | |
| (3 mm) | | | | | | | | | | | | |
| MARHE | | | | | | | | | | | | |
| Smoke | 50 kW/m² | ISO | | | | | | | | | | |
| gas | without | 5659-2 | | | | | | | | | | |
| density | ignition | | | | | | | | | | | |
| (3 mm) | flame | | | | | | | | | | | |
| Ds(4) | | | | 224 | 254 | 249 | 287 | 361 | 217 | 168 | 228 | 190 |
| VOF4 | | | min | 364 | 408 | 432 | 482 | 578 | 355 | 318 | 412 | 376 |

| Feedstock | | | | | | | | | | | |
|---|---|---|---|---|---|---|---|---|---|---|---|
| (% by wt.) | | | | 28 | 29 | 30 | 31 | 32 | 33 | 34 | 35 |
| A-1 | | | | 64 | 65.5 | 68.5 | 70 | 68 | 70.2 | 55.4 | 71.3 |
| B-1 | | | | 4.5 | 4.5 | 4.5 | 4.5 | 4.5 | 4.5 | 4.5 | 4.5 |
| C | | | | 5 | 5 | 5 | 5 | 5 | 5 | 5 | 5 |
| D | | | | 9.5 | 9.5 | 9.5 | 9.5 | 9.5 | 9.5 | 9.5 | 9.5 |
| E-1 | | | | 12.5 | 11 | 8 | 6.5 | | | | |
| E-2 | | | | | | | | 9.5 | 6.3 | | |
| E-3 | | | | | | | | | | 21.1 | 5.2 |
| F-1 | | | | 3.8 | 3.8 | 3.8 | 3.8 | 3.8 | 3.8 | 3.8 | 3.8 |
| F-2 | | | | 0.4 | 0.4 | 0.4 | 0.4 | 0.4 | 0.4 | 0.4 | 0.4 |
| F-3 | | | | 0.2 | 0.2 | 0.2 | 0.2 | 0.2 | 0.2 | 0.2 | 0.2 |
| F-4 | | | | 0.1 | 0.1 | 0.1 | 0.1 | 0.1 | 0.1 | 0.1 | 0.1 |
| Test | Condition | Standard | Unit | | | | | | | | |
| Izod impact | 23° C. | ISO | kJ/m² | 41 | 52 | 84 | 96 | 108 | 124 | 36 | 117 |
| resistance | | 180/1 U | | | | | | | | | |
| Tensile | 1 mm/min | ISO | MPa | 4688 | 4435 | 4147 | 4085 | 4198 | 4145 | 4662 | 4116 |
| modulus | | 527-1, -2 | | | | | | | | | |
| Vicat | 50N; | ISO | ° C. | 100 | 105 | 114 | 120 | 118 | 126 | 145 | 146 |
| softening | 120° C./h | 306 | | | | | | | | | |
| temperature | | | | | | | | | | | |
| Viscosity | | | | | | | | | | | |
| function | | | | | | | | | | | |
| Melt | 260° C. | ISO | Pas | 811 | 911 | 1284 | 1503 | 1220 | 1559 | 2324 | 2708 |
| viscosity | | 11443 | | | | | | | | | |
| [100 s − 1] | | | | | | | | | | | |
| Melt | 260° C. | ISO | Pas | 308 | 342 | 449 | 503 | 413 | 464 | 674 | 775 |
| viscosity | | 11443 | | | | | | | | | |
| [1000 s − 1] | | | | | | | | | | | |
| Melt | 260° C. | ISO | Pas | 243 | 267 | 345 | 376 | 315 | 355 | 515 | 581 |
| viscosity | | 11443 | | | | | | | | | |
| [1500 s − 1] | | | | | | | | | | | |
| Melt | 260° C.; | ISO | cm3/ | 11.2 | 9.3 | 6.2 | 5.1 | 6.5 | 4.0 | 2.8 | 2.5 |
| volume | 5 kg | 1133 | (10 min) | | | | | | | | |
| flow rate | | | | | | | | | | | |
| (MVR) | | | | | | | | | | | |
| ESC in | | | | | | | | | | | |
| rapeseed oil | | | | | | | | | | | |
| Time | 2.4% edge | ISO | h | 21 | 21 | 21 | 21 | 35 | 37 | 25 | 24 |
| until | fibre | 4599 | | | | | | | | | |
| fracture | elongation | | | | | | | | | | |
| Heat | 50 kW/m² | ISO | kW/m² | 44 | 43 | 45 | 42 | 68 | 36 | 82 | 61 |
| release | | 5660-1 | | | | | | | | | |
| (3 mm) | | | | | | | | | | | |
| MARHE | | | | | | | | | | | |
| Smoke | 50 kW/m² | ISO | | | | | | | | | |
| gas | without | 5659-2 | | | | | | | | | |
| density | ignition | | | | | | | | | | |
| (3 mm) | flame | | | | | | | | | | |
| Ds(4) | | | min | 208 | 208 | 198 | 202 | 243 | 153 | 235 | 161 |
| VOF4 | | | min | 343 | 359 | 331 | 348 | 411 | 287 | 416 | 256 |

1. A thermoplastic moulding composition comprising:
A) 50-90% by weight of aromatic polycarbonate or polyestercarbonate having a relative solution viscosity of at least 1.285, measured in CH₂Cl₂ as solvent at 25° C. and a concentration of 0.5 g/100 ml,
B) 1-10% by weight of rubber-modified graft polymer,
C) 2.5-10% by weight of boron nitride,
D) 4-20% by weight of talc,
E) 2-20% by weight of phosphorus-containing flame retardant, and
F) 0-20% by weight of further additives.

2. The composition of claim 1, wherein component A is a branched polycarbonate based on bisphenol A.

3. The composition of claim 1, comprising, as component B, one or more graft polymers of:
B.1 5% to 95% by weight of at least one vinyl monomer, onto
B.2 95% to 5% by weight of at least one graft base selected from the group consisting of diene rubbers, EP(D)M rubbers, acrylate rubbers, polyurethane rubbers, silicone rubbers, chloroprene rubbers, ethylene/vinyl acetate rubbers, and silicone/acrylate composite rubbers.

4. The composition of claim 3, wherein the graft base B.2 is a silicone-acrylate composite rubber composed of mutually penetrating silicone rubber and polyalkyl(meth)acrylate rubber, wherein the proportion of silicone rubber is 50-95% by weight based on B.2.

5. The composition of claim 1, wherein component C is hexagonal boron nitride.

6. The composition of claim 1, wherein component C has a median particle size D50 of 0.1 to 50 μm, determined by laser diffraction.

7. The composition of claim 1, wherein component D has an average particle size d₅₀ of 0.7 to 2.5 μm determined by sedimentation analysis.

8. The composition of claim 1, wherein component E is at least one flame retardant selected from the group comprising oligophosphate, phosphazene and salts of phosphinic acid.

9. The composition of claim 8, wherein component E is a compound having the following structure:

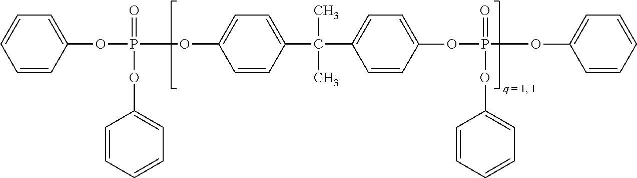

10. The composition of claim 1, wherein component F comprises at least one additive selected from the group consisting of lubricants, mould release agents, antidripping agents, nucleating agents, antistats, conductivity additives, stabilizers, flowability promoters, compatibilizers, further impact modifiers other than component B, further polymeric blend partners, fillers and reinforcers other than component D, and dyes and pigments.

11. The composition of claim 1, wherein component F is zinc borate hydrate Zn₂B₆O₁₁. 3.5H₂O.

12. The composition of claim 1, comprising:
55-80% by weight of component A,
1-8% by weight of component B,
2.5-8% by weight of component C,
5-15% by weight of component D,
3-15% by weight of component E, and
0.1-10% by weight of component F.

13. (canceled)

14. A molded article comprising the composition of claim 1.

15. The molded article of claim 14 having a tensile modulus of elasticity of at least 4000 MPa measured to ISO 527, heat release according to ISO 5660-1 of not more than 90 kW/m², a smoke gas density to ISO 5659-2 of Ds(4) not more than 300 and VOF4 of not more than 600, and a time before fracture in the ESC test in rapeseed oil at an edge fibre elongation of 2.4% of at least two hours.

16. The molded article of claim 14, wherein the article is injection molded or thermoform molded.
